(19) United States
(12) Patent Application Publication
(10) Pub. No.: US 2014/0038026 A1
(43) Pub. Date: Feb. 6, 2014

(54) Energy store with separator

(71) Applicant: Ulrich HASENKOX, Ditzingen (DE)

(72) Inventor: Ulrich HASENKOX, Ditzingen (DE)

(73) Assignee: Robert Bosch GmbH, Stuttgart (DE)

(21) Appl. No.: 13/955,928

(22) Filed: Jul. 31, 2013

(30) Foreign Application Priority Data
Aug. 1, 2012 (DE) 102012213528.6

(51) Int. Cl. H01M 2/16; H01M 2/14

(52) U.S. Cl. CPC H01M 2/1653; H01M 2/145
USPC 429/145; 429/247; 429/249; 429/142; 427/58; 156/60

(57) ABSTRACT

An electrochemical energy store including a cathode space, an anode space, at least one electrolyte solution, the electrolyte solution being in the cathode space and in the anode space, and at least one separator, to separate the cathode space from the anode space. The separator includes a diaphragm, and the diaphragm has a permeability to molecules smaller than or equal to 250 Dalton, the diaphragm having a valence-dependent permeability to the molecules. In addition, also described is a separator for the electrochemical energy store, a method for manufacturing a diaphragm for the separator, and the use of the electrochemical energy store in an electrical device. The long-term stability of the electrochemical energy store may be increased by the present system.

### RELATED APPLICATION INFORMATION

The present application claims priority to and the benefit of German patent application no. 10 2012 213 528.6, which was filed in Germany on Aug. 1, 2012, the disclosure of which is incorporated herein by reference.

### FIELD OF THE INVENTION

The present invention relates to an electrochemical energy store, a separator for the electrochemical energy store, and the use of the electrochemical energy store in an electrical device.

### BACKGROUND INFORMATION

Electrochemical energy stores, for example, lithium-sulfur batteries, offer the advantage over conventional batteries, for example, lithium-ion batteries, of substantially higher energy density.

However, the electrochemical energy stores presently still have an inadequate cycle stability. The available capacity decreases with each charge-discharge cycle in the electrochemical energy stores of the related art. In addition, for example, in the case of a lithium-sulfur battery, the cathode material, such as the quantity of sulfur contained in the cathode, for example, is only incompletely discharged.

### SUMMARY OF THE INVENTION

An object of the present invention is an electrochemical energy store.

The electrochemical energy store includes a cathode space, an anode space, at least one electrolyte solution, the electrolyte solution being in the cathode space and in the anode space, and at least one separator, in order to separate the cathode space from the anode space, the separator including a diaphragm, and the diaphragm having a permeability to molecules smaller than or equal to 250 Dalton, the diaphragm having a valence-dependent permeability to the molecules.

The electrochemical energy store may be a lithium-sulfur battery, for example.

A cathode may be situated in the cathode space, the cathode being able to have a current collector, for example, a metal foil made of aluminum, nickel, or metallically coated polymer and the current collector being able to be coated with a cathode material, for example, a sulfurous mixture having carbon black, graphite, and other conductive carbons.

The cathode material may include a binder, for example, a polymer, such as PVDF, Teflon, or styrene-butadiene copolymers, for holding together the cathode and for adhesion on the current collector.

Furthermore, an anode may be situated in the anode space, the anode being able to have a current collector, for example, a metal foil made of copper, nickel, or metallically coated polymer, and the current collector being able to be coated with an anode material, for example, a metallic lithium foil or lithium in a conductive matrix, for example, carbon.

The at least one electrolyte solution may be made of ethylene glycol dimethyl ethers having one or multiple ethylene glycol units, cyclic ethers, and a lithium salt such as lithium-bis-(trifluoromethyl-sulfonyl)-imide, LiPF6, or other suitable lithium salts, and allows the transport of the lithium ions from the anode space into the cathode space.

The term separator may in this case describe a partition wall between the cathode space and the anode space, which has the task of separating the cathode space and the anode space in the energy store spatially and electrically with the aid of a diaphragm. However, the separator must be permeable to the ions which cause the conversion of the stored chemical energy into electrical energy. The diaphragm of the separator is ion-conductive to allow a process to occur in the energy conductor. Predominantly microporous plastics and microporous ceramic separators may be used as the materials.

The long-term stability of the electrochemical energy store may be increased by the use of a diaphragm in the separator, since the diaphragm has a permeability which is dependent on the size of the molecules and their valence. The diaphragm used according to the present invention has a permeability to molecules smaller than or equal to 250 Dalton.

The delimitation smaller than or equal to does not mean in this case that 100% of the molecules larger than the specified value may not diffuse through the diaphragm, but rather that more than 90% of the molecules larger than or equal to the specified value are held back by the diaphragm. For example, the diaphragm in the area of a lithium-sulfur battery could hold back the dissolved sulfur, which is present as S₈ having a molecular weight of 256 Dalton, in the cathode space, so that it may not reach the anode space and react therein with the lithium of the anode to form Li₂S or Li₂S₂ and precipitate there as insoluble products, and would therefore no longer be available for further cycles in the cathode space, i.e., the sulfur concentration in the cathode space would be reduced.

Furthermore, due to the valence-dependent permeability to the molecules, the diaphragm may prevent the sulfur of the cathode, for example, with the aid of soluble polysulfides, from diffusing at points at which no electrical contact is present. This would also be disadvantageous, since in this way the sulfur concentration is additionally reduced, which significantly decreases the cycle stability in the course of time. Furthermore, the diaphragm may be impermeable to monovalent or multivalent polysulfide anions due to their negative charge, so that the polysulfide anions may not diffuse through the diaphragm and therefore prevent a reaction of the sulfur or the dissolved polysulfide anions with the metallic lithium anode. Simultaneously, Li⁺ ions or short-chain solvent molecules of the at least one electrolyte solution may diffuse through the diaphragm. Due to the use of the separator, for example, the diffusion of soluble intermediate products during the charge/discharge of a lithium-sulfur battery to the anode may thus be prevented. The loss of active material in the electrochemical energy store may thus be prevented and the electrochemical energy store has a longer service life.

The diaphragm of the electrochemical energy store may advantageously have a permeability to molecules smaller than or equal to 250 Dalton, which may be smaller than or equal to 150 Dalton, in particular smaller than or equal to 100 Dalton, the diaphragm may have a permeability larger than or equal to 32 Dalton. The separating effect of the diaphragm may thus advantageously be set in such a way that the loss of active material, in particular sulfur, in the electrochemical energy store is further prevented, whereby advantageously the service life of the electrochemical energy store may be substantially lengthened.

In one advantageous specific embodiment, the diaphragm of the electrochemical energy store may have an impermeability to molecules having a single or multiple negative charge, which may have a triple negative charge, in particular a double negative charge. The separating effect of the diaphragm may thus advantageously also be improved, so that the loss of active material, in particular sulfur, in the electrochemical energy store is prevented, whereby the electrochemical energy store has a substantially longer service life.

It is advantageous if, in the electrochemical energy store, the cathode space and the anode space each have different electrolyte solutions. Electrolyte solutions may thus be used in the electrochemical energy store which are optimized for use in the particular electrode space. A compromise of the properties in the case of the use of a shared electrolyte solution may thus be dispensed with. Furthermore, an electrolyte solution may be used in the cathode space which is not compatible with the anode, and vice versa, whereby the energy density of the electrochemical store may also be improved. For example, an electrolyte made of ethylene glycol dimethyl ethers having one or multiple ethylene glycol units and cyclic ethers may be used as the electrolyte solution in the cathode space, and a nonpolar solvent having few functional groups, for example, linear and cyclic hydrocarbons or organic carbonates, which may react with polysulfide anions, may be used as the electrolyte solution in the anode space.

The diaphragm of the electrochemical energy store may advantageously be at least partially or completely formed from a chemically inert polymer, the chemically inert polymer being durable in the electrolyte solution used. The term chemically inert may designate substances in this case which do not react or only react in a negligibly small amount with potential reaction partners under the particular specified conditions. Polyesters, polyolefins, polyamides, polyimides, fluorinated polymers, cross-linked polyacrylates, and/or polyurethanes may be used as chemically inert polymers. Therefore, the diaphragm may thus be used in the electrochemical energy store without replacement and maintenance. Furthermore, the diaphragm may not be dissolved by the at least one electrolyte solution, whereby harmful byproducts could arise. The separating effect of the diaphragm may thus advantageously be improved further, so that the loss of active material in the electrochemical energy store may be avoided further, whereby the electrochemical energy store has a longer service life.

In one advantageous specific embodiment of the electrochemical energy store, the diaphragm may include an inert porous material, a chemically inert polymer being able to be applied to at least one side of the inert porous material. The inert porous material may be made of the material polyesters, polyolefins, polyamides, polyimides, and/or fluorinated polymers and may have a porosity of 20% to 80% and pores in the size from 25 nm to 1 μm. The manufacturing costs may thus be reduced, since the inert porous material is generally less costly than the chemically inert polymer. Furthermore, with the aid of the inert porous material, a basis may be provided for various diaphragms, such diaphragms differing due to the chemically inert polymers applied in each case. Furthermore, for example, if a chemically inert material is applied to two sides of the inert porous material, the two sides being able to be situated diametrically opposite, different chemically inert polymers may be applied to the two sides of the inert porous material. The chemically inert polymers may thus be adapted to the particular electrolyte solution present in the electrode space. The separating effect may be ensured by a thinner separator due to the use of a separator having a diaphragm and, for example, two different applied chemically inert polymers, whereby the installation space of the separator may be reduced.

It is advantageous if the permeability of the diaphragm of the electrochemical energy store is settable by the application of the chemically inert polymer to the inert porous material of the diaphragm. By applying the chemically inert polymer to the inert porous material of the diaphragm, the mean pore size of the diaphragm, the degree of cross-linking of the diaphragm, and the mean degree of opening of the diaphragm may be set. The diaphragm may have a mean pore size of 1 nm to 5 nm, the degree of cross-linking of the diaphragm may be 10% to 50%, and the diaphragm may have a mean degree of opening of 30% to 70%. A diaphragm may thus be manufactured in accordance with the desired properties for the electrochemical energy store.

The separating effect of the diaphragm may thus be advantageously improved further, so that the loss of active material in the electrochemical energy store may be reduced further, whereby the electrochemical energy store has a longer service life.

The chemically inert polymer may advantageously be applied to the inert porous material of the diaphragm of the electrochemical energy store by coating, laminating, and/or printing. Due to the different forms of application, it is possible to adapt the manufacturing process of the diaphragm of the separator to existing manufacturing techniques and facilities.

In one advantageous specific embodiment, the diaphragm of the electrochemical energy store may have a thickness of less than or equal to 25 μm, which may be a thickness of less than or equal to 5 μm, in particular a thickness of less than or equal to 1 μm. The separating effect of the diaphragm may thus be ensured even in the case of a very thin diaphragm. Furthermore, a thin diaphragm may have a favorable effect on the diffusion speed of the Li⁺ ions, so that the performance of the electrochemical energy store may advantageously be improved further.

With respect to further features and advantages of the electrochemical energy store according to the present invention, reference is hereby explicitly made to the explanations in conjunction with the separator, the method according to the present invention for manufacturing a diaphragm for the separator, and the use according to the present invention of the energy store in an electrical device, as well as to the figure.

Furthermore, the object of the present invention is a separator for an electrochemical energy store, in particular a lithium-sulfur battery, the separator being situated in the electrochemical energy store, and separating a cathode space from an anode space, and the separator including a diaphragm, the diaphragm having a permeability to molecules smaller than or equal to 250 Dalton, and the diaphragm having a valence-dependent permeability to the molecules. Due to the use according to the present invention of a separator having a diaphragm, the long-term stability of the electrochemical energy store may be significantly increased, since the diaphragm has a permeability dependent on the size of the molecules and their valence. The diaphragm has a permeability to molecules smaller than or equal to 250 Dalton. For example, the diaphragm in the area of a lithium-sulfur battery could hold back the dissolved sulfur, which is present as S₈ having a molecular weight of 256 Dalton, in the cathode space, so that it may not reach the anode space and react therein with the lithium of the anode to form Li₂S or Li₂S₂ and precipitate there as insoluble products and would therefore no longer be available for further cycles. Furthermore, due to the valence-dependent permeability to the molecules, the diaphragm may prevent the sulfur of the cathode from diffusing through soluble polysulfides at points at which electrical contact is no longer present. In this way, the sulfur would be withdrawn from the reaction cycle. Furthermore, the diaphragm may be impermeable to monovalent or multivalent polysulfide anions due to their negative charge. In this way, the polysulfide anions may not diffuse through the diaphragm, so that a reaction of the sulfur or the dissolved polysulfide anions with the metallic lithium anode is prevented. Simultaneously, Li⁺ ions or short-chain solvent molecules of the electrolyte solution may diffuse through the diaphragm. Due to the use of the separator, for example, the diffusion of soluble intermediate products during the charge/discharge of, for example, a lithium-sulfur battery to the anode may thus be prevented. The loss of active material, in particular sulfur, in the electrochemical energy store may thus be prevented and the electrochemical energy store has a longer service life.

The separator may advantageously include a frame, at least one diaphragm being able to be situated in the frame. The separator may thus be made of a stable, cost-effective material and the separating effect of the separator may be carried out by the diaphragm situated in the separator. A thin barrier may thus be provided, which may have a favorable effect on the diffusion speed of, for example, Li⁺ ions, whereby the performance and the service life of the electrochemical energy store may be improved.

With respect to further features and advantages of the separator according to the present invention, reference is hereby explicitly made to the explanations in conjunction with the energy store according to the present invention, the method according to the present invention for manufacturing a diaphragm for the separator, and the use according to the present invention of the energy store in an electrical device, as well as to the figure.

Furthermore, the object of the present invention is a method for manufacturing a diaphragm for a separator of an electrochemical energy store, in particular a lithium-sulfur battery, including at least the following steps: providing an inert porous material, applying a chemically inert polymer to at least one side of the inert porous material. The inert porous material may be made of the material polyesters, polyolefins, polyamides, polyimides, fluorinated polymers, cross-linked polyacrylates, and/or polyurethanes and may have a porosity of 20% to 80%, and pores in the size from 25 nm to 1 μm. The chemically inert material may be a polyamide, polyimide, cross-linked polyacrylates, fluorinated polymers, and/or a polyelectrolyte. The manufacturing method may thus be simplified and the manufacturing costs may be reduced, since the inert porous material is generally less costly than the chemically inert polymer. Furthermore, for example, if a chemically inert material is applied on two sides of the inert porous material, the two sides being able to be situated diametrically opposite, different chemically inert polymers may be applied to the two sides of the inert porous material. The chemically inert polymers may thus be adapted to the particular electrolyte solution present in the electrode space. The separating effect may thus be ensured by a thinner separator due to the use of a separator having a diaphragm made of two different applied chemically inert polymers, whereby the installation space of the separator may be reduced.

In the case of the method, the chemically inert polymer may advantageously be applied to the at least one side of the inert material by coating, laminating, and/or printing. Due to the different forms of application, it is possible to adapt the manufacturing process of the diaphragm to existing manufacturing techniques and facilities. Providing new facilities may thus be omitted.

It is advantageous if, in the case of the method, the permeability of the diaphragm is set by the application of the chemically inert polymer to the inert porous material of the diaphragm. The layer thickness of the chemically inert material may be less than or equal to 5 μm, advantageously less than or equal to 1 μm due to the method. Due to the supporting structure of the porous inert material, the diaphragm may be configured as thin as possible, which keeps the internal resistance of the battery as low as possible. The pore size of the diaphragm may be less than or equal to 10 nm. The loss of active material in the electrochemical energy store may thus be prevented and the electrochemical energy store will have a longer service life.

With respect to further features and advantages of the method according to the present invention, reference is hereby explicitly made to the explanations in conjunction with the electrochemical energy store according to the present invention, the separator according to the present invention, and the use according to the present invention of the energy store in an electrical device, and to the figures.

Furthermore, the object of the present invention is the use of an electrochemical energy store in motor vehicle applications, stationary energy stores, power tools, entertainment electronics, and/or household electronics.

With respect to further features and advantages of the method according to the present invention, reference is hereby explicitly made to the explanations in conjunction with the energy store according to the present invention, the separator according to the present invention, and the method according to the present invention for manufacturing a diaphragm for the separator, and to the figure.

Further advantages and advantageous embodiments of the objects according to the present invention are illustrated by the drawing and the examples and explained in the following description. It is to be noted that the drawing and the examples only have descriptive character and are not intended to restrict the present invention in any way.

### BRIEF DESCRIPTION OF THE DRAWING

FIG. 1 shows a schematic sectional view from the side of a detail of an electrochemical energy store according to one specific embodiment of the present invention.

### DETAILED DESCRIPTION

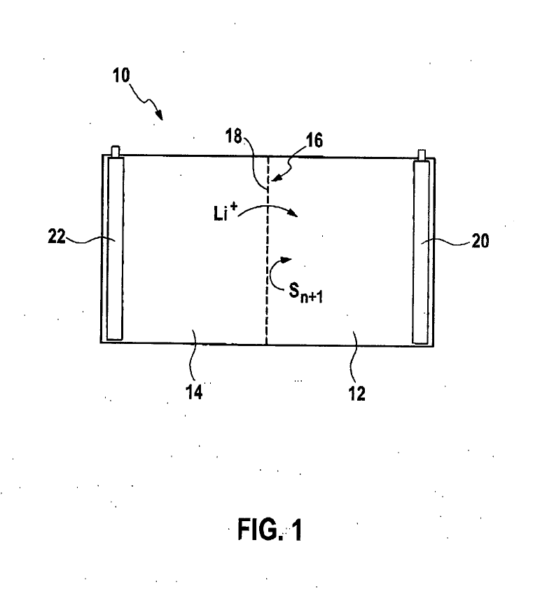

FIG. 1 shows a schematic sectional view of an electrochemical energy store 10. Electrochemical energy store 10 includes a cathode space 12 and an anode space 14. Cathode space 12 and anode space 14 have an electrolyte solution, FIG. 1 not showing that cathode space 12 and anode space 14 each have different electrolyte solutions, the electrolyte solution in cathode space 12 being selected from ethylene glycol dimethyl ethers having one or multiple ethylene glycol units, cyclic ethers, and a lithium salt such as lithium-bis-(trifluoromethyl-sulfonyl)-imide, LiPF6, and/or other suitable lithium salts, and the electrolyte solution in anode space 14 being selected from suitable electrolyte solvents from the field of ethers, carbonates, aromatics, alkanes, or ionic liquids or containing mixtures thereof. A separator 16 is situated in electrochemical energy store 10. Separator 16 separates cathode space 12 from anode space 14. Furthermore, separator 16 includes a diaphragm 18.

In this exemplary embodiment, cathode space 12 has a cathode 20. Cathode 20 has a current collector, such as an aluminum foil, to which a cathode material is applied. The cathode material is made of sulfur and a conductive additive such as carbon black. A binder, such as a polymer, is part of the cathode material for the cohesion of cathode 20 and for adhesion of the cathode material on the current collector. Furthermore, an anode 22 is situated in anode space 14. Anode 22 has a current collector, such as a copper foil, to which an anode material is applied. The anode material is made of a metallic lithium foil.

Diaphragm 18 of separator 16 has a permeability to molecules smaller than or equal to 250 Dalton. Furthermore, diaphragm 18 is impermeable to molecules having a double negative charge. This is shown in FIG. 1 in such a way that Li⁺ ions may defuse through diaphragm 18 from anode space 14 into cathode space 12, while simultaneously Sₙ₊₁ ions may not diffuse from cathode space 12 into anode space 14. Due to the negative charge of Sₙ₊₁ ions and due to their molecular size, diaphragm 18 is impermeable to the Sₙ₊₁ ions. This is shown in FIG. 1 on the basis of the arrow, which makes an arc back into cathode space 12. All chemically inert polymers which are durable in the electrolyte solutions used are suitable as materials.

In this exemplary embodiment, diaphragm 18 is partially formed from a chemically inert polymer. Diaphragm 18 includes an inert porous material, and the chemically inert polymer is applied to at least one side of the chemically inert porous material. The permeability of diaphragm 18 is set by the application of the chemically inert polymer to the inert porous material of diaphragm 18. A mean pore size in the level of 1 nm to 10 nm and the degree of cross-linking in the level of 10% to 50% of diaphragm 18 is thus also set. The chemically inert polymer is applied to the inert porous material of diaphragm 18 by coating. Furthermore, it is also possible that the chemically inert polymer is applied to the inert porous material of diaphragm 18 by laminating and/or printing. After the application, the diaphragm has a thickness less than or equal to 5 μm, so that the thin barrier also has a favorable effect on the diffusion speed of the Li⁺ ions.

Separator 16 includes a frame (not shown). Diaphragm 18 is situated in the frame.

Diaphragm 18 of separator 16 may be manufactured in a method including at least the following steps: providing an inert porous material, and applying a chemically inert polymer to at least one side of the inert porous material. In this exemplary embodiment, the chemically inert polymer is applied to the at least one side of the inert material by coating. In addition to coating, in the method, the chemically inert polymer may also be applied to the at least one side of the inert material by laminating or printing. The permeability of diaphragm 18 is set by the application of the chemically inert polymer to the inert porous material of diaphragm 18. The layer thickness of the chemically inert polymer is less than or equal to 5 μm, and the polymer is a polyamide, polyimide, cross-linked polyacrylate, fluorinated polymer, and/or a polyelectrolyte.

Above-described electrochemical energy store 10 may be used in motor vehicle applications, stationary energy stores, power tools, entertainment electronics, and/or household electronics.

What is claimed is:

1. An electrochemical energy store, comprising:
a cathode space;
an anode space;
at least one electrolyte solution, the electrolyte solution being situated in the cathode space and in the anode space; and
at least one separator to separate the cathode space from the anode space, wherein the separator includes a diaphragm, wherein the diaphragm has a permeability to molecules smaller than or equal to 250 Dalton, and wherein the diaphragm has a valence-dependent permeability to the molecules.

2. The electrochemical energy store of claim 1, wherein the diaphragm has a permeability to molecules smaller than or equal to 250 Dalton.

3. The electrochemical energy store of claim 1, wherein the diaphragm is impermeable to molecules or ions having a double negative charge.

4. The electrochemical energy store of claim 1, wherein the cathode space and the anode space each have different electrolyte solutions.

5. The electrochemical energy store of claim 1, wherein the diaphragm is at least partially or completely formed from a chemically inert polymer.

6. The electrochemical energy store of claim 1, wherein the diaphragm includes an inert porous material, and a chemically inert polymer is applied to at least one side of the chemically inert porous material.

7. The electrochemical energy store of claim 1, wherein the permeability of the diaphragm is settable by the application of the chemically inert polymer to the inert porous material of the diaphragm.

8. The electrochemical energy store of claim 1, wherein the chemically inert polymer is applicable to the inert porous material of the diaphragm by at least one of coating, laminating, and printing.

9. The electrochemical energy store of claim 1, wherein the diaphragm has a thickness of less than or equal to 25 μm.

10. A separator for an electrochemical energy store, comprising:
a diaphragm having a permeability to molecules smaller than or equal to 250 Dalton;
wherein the diaphragm has a valence-dependent permeability to the molecules, and
wherein the separator is situated in the electrochemical energy store and separates a cathode space from an anode space.

11. The separator of claim 10, wherein the separator includes a frame, and wherein at least one diaphragm is situated in the frame.

12. A method for manufacturing a diaphragm for a separator of an electrochemical energy store, the method comprising:
providing an inert porous material; and
applying a chemically inert polymer to at least one side of the inert porous material;
wherein the separator of the electrochemical energy store includes a diaphragm having a permeability to molecules smaller than or equal to 250 Dalton, the diaphragm having a valence-dependent permeability to the molecules, and the separator being situated in the electrochemical energy store and separating a cathode space from an anode space.
wherein the electrochemical energy store includes the cathode space and the anode space, at least one electrolyte solution, and the separator, the electrolyte solution being situated in the cathode space and in the anode space.

13. The method of claim 12, wherein the chemically inert polymer is applied to the at least one side of the inert material by at least one of coating, laminating, and printing.

14. The method of claim 12, wherein the permeability of the diaphragm is set by the application of the chemically inert polymer to the inert porous material of the diaphragm.

15. The method of claim 12, wherein the electrochemical energy store is a lithium-sulfur battery.

16. A use of an electrochemical energy store (10) as recited in one of claims 1 through 9 in motor vehicle applications, stationary energy stores, power tools, entertainment electronics, and/or household electronics.

17. The electrochemical energy store of claim 1, wherein the diaphragm has a permeability to molecules smaller than or equal to 150 Dalton.

18. The electrochemical energy store of claim 1, wherein the diaphragm has a permeability to molecules smaller than or equal to 100 Dalton.

19. The electrochemical energy store of claim 1, wherein the diaphragm has a thickness of less than or equal to 5 μm.

20. The electrochemical energy store of claim 1, wherein the diaphragm has a thickness of less than or equal to 1 μm.

21. The separator of claim 10, wherein the electrochemical energy store is a lithium-sulfur battery.
